(19) United States
(12) Patent Application Publication
(10) Pub. No.: US 2013/0063421 A1
(43) Pub. Date: Mar. 14, 2013

(54) THREE-DIMENSIONAL IMAGE DISPLAY

(71) Applicants: Ilyong Yoon, Seoul (KR); Jinhwan Kim, Suwon-si (KR)

(72) Inventors: Ilyong Yoon, Seoul (KR); Jinhwan Kim, Suwon-si (KR)

(21) Appl. No.: 13/402,594

(22) Filed: Feb. 22, 2012

(30) Foreign Application Priority Data
Sep. 9, 2011 (KR) 10-2011-0091674

(51) Int. Cl. G06T 15/00

(52) U.S. Cl. 345/419

(57) ABSTRACT

A three-dimensional (3D) image display includes a display panel including regions arranged in a first direction and an image converting unit that converts a two-dimensional (2D) image displayed on the display panel into a 3D image. Each of a first region and a second region includes columns sequentially arranged in the first direction and a first pixel pattern or a second pixel pattern is included in each of the columns. The first and second pixel patterns each include first, second, third, and fourth color cells arranged in a second direction different from the first direction. The arrangement of the first to fourth color cells in the first pixel pattern is different from the arrangement of the first to fourth color cells in the second pixel pattern. The first and second pixel patterns are alternately arranged in corresponding columns of the first and second regions.

### CROSS-REFERENCE TO RELATED APPLICATION

This application claims priority to Korean Patent Application No. 10-2011-0091674 filed on Sep. 9, 2011, the disclosure of which is incorporated by reference herein in its entirety.

### TECHNICAL FIELD

The present inventive concept relates to a three-dimensional (3D) image display.

### DISCUSSION OF THE RELATED ART

In general, a 3D image display is classified as a stereoscopic display and an auto-stereoscopic display. A viewer has to wear eyeglasses to observe 3D images from the stereoscopic display; while in the auto-stereoscopic display, no glasses are required. The auto-stereoscopic display may employ a barrier method and a lenticular method. The barrier method uses a parallax barrier, e.g., a layer of material with a series of slits, placed in front of an image source to allow it to show a 3D image. The lenticular method refracts light passing through different pixels with an array of lenticular lenses to create a parallax, thereby displaying a 3D image. In a display panel employing the lenticular method, pixels are arranged in a matrix form and axes of the lenticular lenses are arranged in a direction corresponding to the arrangement direction of the pixels.

In addition, a multiview 3D image display, which may use the auto-stereoscopic method to allow glasses-free viewing of stereoscopic images from arbitrary positions, has a resolution depending on a resolution of its two-dimensional (2D) image display panel. For example, as the resolution of the 2D image display panel increases, the resolution of the 3D image display increases. However, as the number of viewpoints increases, the resolution of the 3D image display drops. Accordingly, there is a need to better the resolution of a 3D image display.

### SUMMARY

Exemplary embodiments of the present invention provide a three-dimensional (3D) image display with improved image display quality.

According to an exemplary embodiment of the present invention, a 3D image display includes a display panel including a plurality of regions arranged in a first direction and an image converting unit disposed on the display panel to convert a two-dimensional (2D) image displayed on the display panel into a 3D image. Each of a first region and a second region of the plurality of regions includes a plurality of columns sequentially arranged in the first direction and a first pixel pattern or a second pixel pattern is included in each of the columns. The first and second pixel patterns each include first, second, third, and fourth color cells arranged in a second direction different from the first direction, the arrangement of the first to fourth color cells in the first pixel pattern is different from the arrangement of the first to fourth color cells in the second pixel pattern, and the first and second pixel patterns are alternately arranged in corresponding columns of the first and second regions.

According to an exemplary embodiment of the present invention, the second color cell and the fourth color cell include a same color and in the second pixel pattern the third color cell, the second color cell, the first color cell, and the fourth color cell are sequentially arranged in the second direction.

According to an exemplary embodiment of the present invention, the first and third color cells have a same length in the second direction, the second and fourth color cells have a same length in the second direction, and a ratio of the length of each of the first and third color cells to the length of each of the second and fourth color cells is about 1:0.5.

According to an exemplary embodiment of the present invention, the first color cell is a red cell, each of the second and fourth color cells is a green cell, and the third color cell is a blue cell.

According to an exemplary embodiment of the present invention, the second color cell and the third color cell have a same color and in the second pixel pattern the fourth color cell, the second color cell, the third color cell, and the first color cell are sequentially arranged in the second direction.

According to an exemplary embodiment of the present invention, the first and fourth color cells have a same length in the second direction, the second and third color cells have a same length in the second direction, and a ratio of the length of each of the first and fourth color cells to the length of each of the second and third color cells is about 1:0.5.

According to an exemplary embodiment of the present invention, the first color cell is a red cell, each of the second and third color cells is a green cell, and the fourth color cell is a blue cell.

According to an exemplary embodiment of the present invention, the first, second, third, and fourth color cells have different colors from each other and in the second pixel pattern the third color cell, the fourth color cell, the first color cell, and the second color cell are sequentially arranged in the second direction.

According to an exemplary embodiment of the present invention, the first, second, third, and fourth color cells correspond to red, green, blue, and white cells, respectively.

According to an exemplary embodiment of the present invention, the columns of the first region have different viewpoints from each other and the columns of the second region have different viewpoints from each other, wherein the corresponding columns of the first and second regions have a same viewpoint.

According to an exemplary embodiment of the present invention, the first pixel pattern and the second pixel pattern are alternately arranged in the columns of each of the first and second regions.

According to an exemplary embodiment of the present invention, the image converting unit may include a plurality of lenticular lenses.

According to an exemplary embodiment of the present invention, a first lenticular lens and a second lenticular lens of the lenticular lenses respectively correspond to the first and second regions and each of the first and second lenticular lenses has a lens axis substantially parallel with the second direction.

According to an exemplary embodiment of the present invention, the first and second lenticular lenses are extended in the second direction and arranged in the first direction and each of the first and second lenticular lenses is overlapped with a plurality of the color cells arranged in the first direction.

According to an exemplary embodiment of the present invention, the image converting unit may include a plurality of viewpoint dividing devices, a first viewpoint dividing device and a second viewpoint dividing device of the viewpoint dividing devices are extended in the second direction and arranged in the first direction, and each of the first and second viewpoint dividing devices is overlapped with a plurality of the color cells arranged in the first direction.

According to an exemplary embodiment of the present invention, each of the first and second lenticular lenses has a lens axis inclined at a first angle with respect to the second direction.

According to an exemplary embodiment of the present invention, a 3D image display includes a display panel including a plurality of regions arranged in a first direction; and an image converting unit disposed on the display panel to convert a 2D image displayed on the display panel into a 3D image, wherein each of a first region and a second region of the plurality of regions comprises a plurality of columns sequentially arranged in the first direction, first, second, third and fourth pixel patterns are arranged in the columns of each of the first and second regions in a second direction different from the first direction, the first to fourth pixel patterns include first, second, third and fourth color cells different from each other, in the first pixel pattern the first, second, third and fourth color cells are sequentially arranged in the second direction, in the second pixel pattern the second, third, fourth and first color cells are sequentially arranged in the second direction, in the third pixel pattern the third, fourth, first and second color cells are sequentially arranged in the second direction, and in the fourth pixel pattern the fourth, first, second and third color cells are sequentially arranged in the second direction.

The first to fourth pixel patterns may be sequentially arranged in the first direction in each of the first and second regions.

The sequential arrangement of the first to fourth pixel patterns in the first direction may be repeated in the first and second regions.

The first, second, third and fourth color cells may correspond to red, green, blue and white cells, respectively.

According to an exemplary embodiment of the present invention, a 3D image display includes a display panel including a first region and a second region, wherein the first region includes a plurality of columns and the second region includes a plurality of columns; a first lens disposed over the first region; and a second lens disposed over the second region, wherein a first pixel pattern and a second pixel pattern are alternately arranged in the columns of each of the first and second regions in a first direction, the first pixel pattern and the second pixel pattern each include at least four color cells arranged in a second direction different from the first direction, and the arrangement of the color cells in the first pixel pattern is different from the arrangement of the color cells in the second pixel pattern.

### BRIEF DESCRIPTION OF THE DRAWINGS

The above and other features of the present invention will become more apparent by describing in detail exemplary embodiments thereof with reference to the accompanying drawings in which:

FIG. 1 is a perspective view showing a three-dimensional (3D) image display apparatus according to an exemplary embodiment of the present invention;

FIG. 2 is a plan view showing color cells arranged in a display panel shown in FIG. 1 according to an exemplary embodiment of the present invention;

FIG. 3 is a plan view showing lenticular lenses arranged on the display panel shown in FIG. 2 according an exemplary embodiment of the present invention;

FIG. 4 is a plan view showing lenticular lenses arranged on a display panel according to an exemplary embodiment of the present invention;

FIG. 5 is a plan view showing color cells arranged in a display panel according to an exemplary embodiment of the present invention;

FIG. 6 is a plan view showing lenticular lenses arranged on the display panel shown in FIG. 5 according an exemplary embodiment of the present invention;

FIG. 7 is a plan view showing lenticular lenses arranged on a display panel according to an exemplary embodiment of the present invention;

FIG. 8 is a plan view showing color cells arranged in a display panel according to an exemplary embodiment of the present invention;

FIG. 9 is a plan view showing color cells arranged in a display panel according to an exemplary embodiment of the present invention;

FIG. 10 is a plan view showing lenticular lenses arranged on the display panel shown in FIG. 9 according an exemplary embodiment of the present invention; and

FIG. 11 is a plan view showing color cells arranged in a display panel according to an exemplary embodiment of the present invention.

### DETAILED DESCRIPTION OF EXEMPLARY EMBODIMENTS

Exemplary embodiments of the present invention will be described more fully hereinafter with reference to the accompanying drawings. However, the present invention may be embodied in various different ways and should not be construed as limited to the exemplary embodiments described herein.

It will be understood that when an element or layer is referred to as being “on,” “connected to” or “coupled to” another element or layer, it can be directly on, connected or coupled to the other element or layer or intervening elements or layers may be present. Like numbers may refer to like elements throughout the specification and drawings.

As used herein, the singular forms, “a,” “an” and “the” are intended to include the plural forms as well, unless the context clearly indicates otherwise.

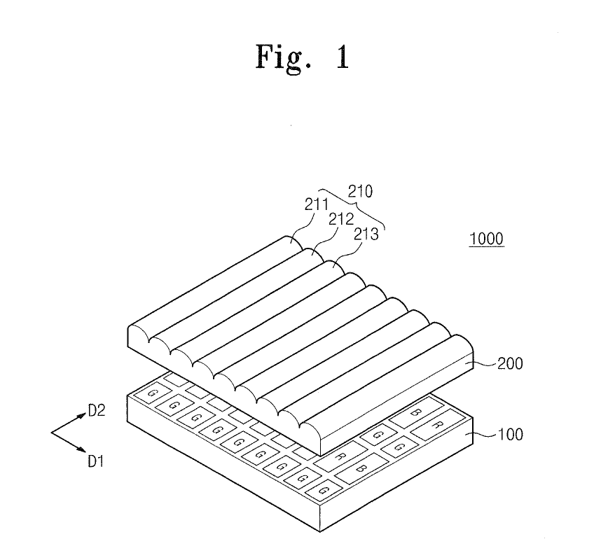

FIG. 1 is a perspective view showing a three-dimensional (3D) image display apparatus 1000 according to an exemplary embodiment of the present invention.

Referring to FIG. 1, the 3D image display apparatus 1000 includes a display panel 100 for displaying an image and an image converting unit 200 for converting the image displayed on the display panel 100.

The display panel 100 includes a thin film transistor substrate (not shown), an opposite substrate (not shown), and a liquid crystal layer (not shown). The display panel 100 may further include a light blocking pattern (not shown). The thin film transistor substrate and the opposite substrate define a plurality of pixels on the display panel 100. Each pixel includes a plurality of color cells. The color cells are repeatedly arranged in a first direction D1 and a second direction D2 crossing the first direction D1 to be arranged in a matrix form.

The color cells display colors using color filters disposed on the thin film transistor substrate or the opposite substrate. When the color filters include red, green, and blue color filters, the color cells include a red cell R, a green cell G, and a blue cell B. According to an exemplary embodiment of the present invention, the color filters may further include a fourth color. The fourth color may be a white W, cyan C, magenta M, or yellow Y color.

The image converting unit 200 controls the light exiting from the display panel 100 to convert a two-dimensional (2D) image displayed on the display panel 100 into a 3D image. The image converting unit 200 includes a plurality of lenticular lenses 210. According to an exemplary embodiment of the present invention, the image converting unit 200 may be realized by liquid crystal lenses, or Fresnel lenses. Accordingly, the image converting unit 200 should not be limited to the lenticular lenses 210. In fact, the image converting unit 200 may include various other devices to realize a multi-viewpoint 3D image.

The lenticular lenses 210 are extended in the second direction D2 and arranged in the first direction D1. Each lenticular lens 210 is overlapped with a plurality of color cells arranged in the first direction D1. In the present exemplary embodiment, each lenticular lens 210 has a curved surface protruded away from the display panel 100. Accordingly, each lenticular lens 210 has a semi-circular shape in a cross-sectional view. For convenience of explanation, the lenticular lenses 210 sequentially arranged along the first direction D1 are referred to as a first lenticular lens 211, a second lenticular lens 212, and a third lenticular lens 213.

When the image converting unit 200 includes a plurality of viewpoint dividing devices, such as the liquid crystal lenses or Fresnel lenses instead of the lenticular lenses 210 to realize the multi-viewpoints, these devices may be extended in the second direction D2 and arranged in the first direction D1. In this case, each liquid crystal lens or each Fresnel lens is overlapped with the color cells arranged in the first direction D1, e.g., nine color cells.

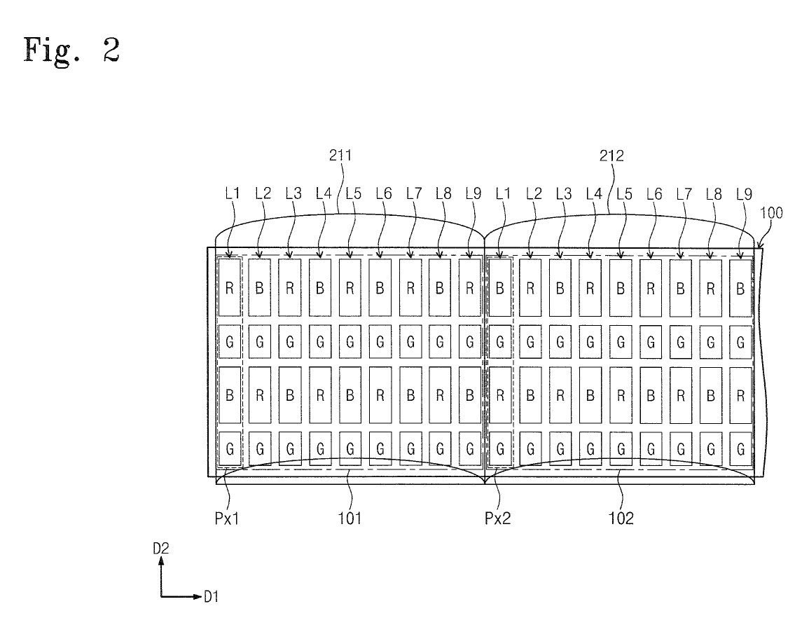

FIG. 2 is a plan view showing color cells arranged in the display panel 100 shown in FIG. 1 according to an exemplary embodiment of the present invention.

Referring to FIG. 2, the lenticular lenses 211 and 212 are disposed on the display panel 100. The display panel 100 includes a first region 101 and a second region 102 corresponding to the lenticular lenses 211 and 212, respectively. In FIG. 2, a portion of the display panel 100 has been shown, and thus the display panel 100 includes the first region 101 and the second region 102, but the number of the regions defined on the display panel 100 depends on the resolution of the display panel 100. For instance, when the display panel 100 has a resolution of 1920×1080, (1920×3) color cells are arranged in the first direction D1. Since each lenticular lens 210 is overlapped with nine color cells, each of the number of the lenticular lenses 210 and the number of the regions defined on the display panel 100 is ((1920×3)/9).

Each of the first region 101 and the second region 102 includes first to ninth lines L1 to L9 extended in the second direction D2 and repeatedly arranged in the first direction D1. Each of the first to ninth lines L1 to L9 includes a first pixel pattern Px1 in which first to fourth color cells are arranged in the second direction D2 or a second pixel pattern Px2 different from the first pixel pattern Px1. Therefore, the first to fourth color cells are repeatedly arranged in the first direction D1 and the second direction D2 to form the matrix. The color cells arranged in the first direction D1 are spaced apart from each other and the color cells arranged in the second direction D2 are spaced apart from each other.

The first, second, third, and fourth color cells respectively correspond to the red cell R, the green cell G, the blue cell B, and the green cell G. The first pixel pattern Px1 includes the red cell R, the green cell G, the blue cell B, and the green cell G sequentially arranged in the second direction D2. The second pixel pattern Px2 includes the blue cell B, the green cell G, the red cell R, and the green cell G sequentially arranged in the second direction D2. Either the first pixel pattern Px1 or the second pixel pattern Px2 is provided in each of the first to ninth lines L1 to L9.

Each of the first to fourth color cells includes a short side extended in the first direction D1 and a long side extended in the second direction D2. The long side of the red cell R and the blue cell B provided as the first and third color cells is two times longer than the long side of the green cell G provided as the second and fourth color cells. In other words, a ratio of the long side of the red cell R to the long side of the green cell G is about 1:0.5 and a ratio of the long side of the blue cell B to the long side of the green cell G is about 1:0.5.

As shown in FIG. 2, the first pixel pattern Px1 and the second pixel pattern Px2 are alternately arranged in the first to ninth lines L1 to L9 of the first region 101 along the first direction D1, and the second pixel pattern Px2 and the first pixel pattern Px1 are alternately arranged in the first to ninth lines L1 to L9 of the second region 102 along the first direction D1. For instance, the first pixel pattern Px1 is arranged in the first line L1 of the first region 101 and the second pixel pattern Px2 is arranged in the first line L1 of the second region 102. In addition, the second pixel pattern Px2 is arranged in the second line L2 of the first region 101 and the first pixel pattern. Px1 is arranged in the second line L2 of the second region 102. When each of the first and second regions 101 and 102 includes an odd number of lines, the last line, e.g., the ninth line L9, of the first region 101 and the first line L1 of the second region 102 include different pixel patterns from each other. For example, the ninth line L9 of the first region 101 may include the first pixel pattern Px1 and the first line L1 of the second region 102 may include the second pixel pattern Px2. However, when each of the first and second regions 101 and 102 includes an even number of the lines, the last line, e.g., the eighth line L8, of the first region 101 and the first line L1 of the second region 102 may include the same pixel pattern. For example, the eighth line L8 of the first region 101 and the first line L1 of the second region 102 may include the first pixel pattern Px1, or the eighth line L8 of the first region 101 and the first line L1 of the second region 102 may include the second pixel pattern Px2. In this case, each of the lines arranged in the first region 101 includes a pixel pattern different from a pixel pattern arranged in a corresponding line of the lines of the second region 102.

As described above, since the first and second pixel patterns Px1 and Px2 are alternately arranged in corresponding lines of the first and second regions 101 and 102, adjacent color cells may have different colors from each other in each of first to ninth viewpoints, thereby improving the quality of the 3D image.

Further, each pair of the first pixel pattern Px1 including the red cell R, the green cell G, the blue cell B, and the green cell G sequentially arranged in the second direction D2 and the second pixel pattern Px2 including the blue cell B, the green cell G, the red cell R, and the green cell G sequentially arranged in the second direction D2 forms two pixels with four color cells in each pixel. Therefore, the number of the color cells (e.g., sub-pixels) in the second direction D2 may be reduced by ⅓ as compared with a six color cell per pixel pair of pixels, so that the resolution of the display panel 100 may be improved.

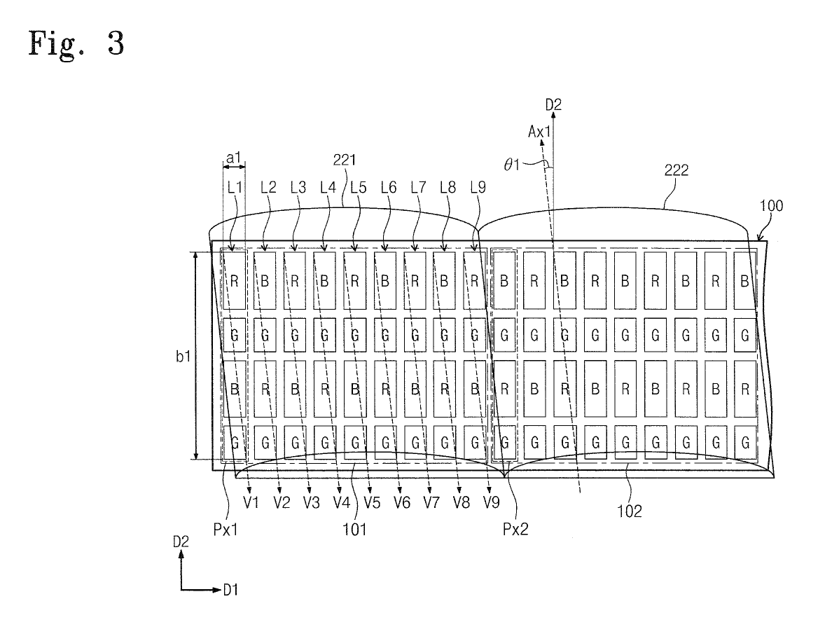

FIG. 3 is a plan view showing lenticular lenses arranged on the display panel 100 shown in FIG. 2 according an exemplary embodiment of the present invention.

Referring to FIG. 3, lenticular lenses 221 and 222 disposed on the display panel 100 have a lens axis Ax1 inclined in a counter-clockwise direction by an inclination angle θ1 with respect to the second direction D2. These lenses are different from the lenticular lenses 211 and 212 shown in FIG. 2. The lenticular lenses 221 and 222 are extended along the lens axis Ax1 and arranged in the first direction D1 to be substantially parallel with each other.

The inclination angle θ1 of the lens axis Ax1 may be defined by the following equation 1 according to the structure of the color cells in the display panel 100.

$$tan ( θ 1 ) = \frac{a 1}{b 1} \qquad Equation 1$$

In equation 1, b1 denotes a length of one pixel pattern in the second direction D2 and a1 denotes a length of the one pixel pattern in the first direction D1.

First to ninth viewpoint lines V1 to V9 are substantially parallel with the lens axis Ax1 of the lenticular lenses 221 and 222. The first viewpoint line V1 substantially parallel with the lens axis Ax1 is disposed on the red cell R, the green cell G, the blue cell B, and the green cell G of the first line L1. The second viewpoint line V2 substantially parallel with the first viewpoint line V1 is disposed on the blue cell B, the green cell G, the red cell R, and the green cell G of the second line L2. Each of the third, fifth, seventh, and ninth viewpoint lines V3, V5, V7 and V9 is disposed on the red cell R, the green cell G, the blue cell B, and the green cell G of the third, fifth, seventh and ninth lines L3, L5, L7 and L9, respectively, and each of fourth, sixth, and eighth viewpoint lines V4, V6, and V8 is disposed on the blue cell B, the green cell G, the red cell R, and the green cell G of the fourth, sixth and eighth lines L4, L6 and L8, respectively. Thus, a moiré phenomenon may be prevented from occurring when an observer's eyes converge on a boundary between adjacent color cells.

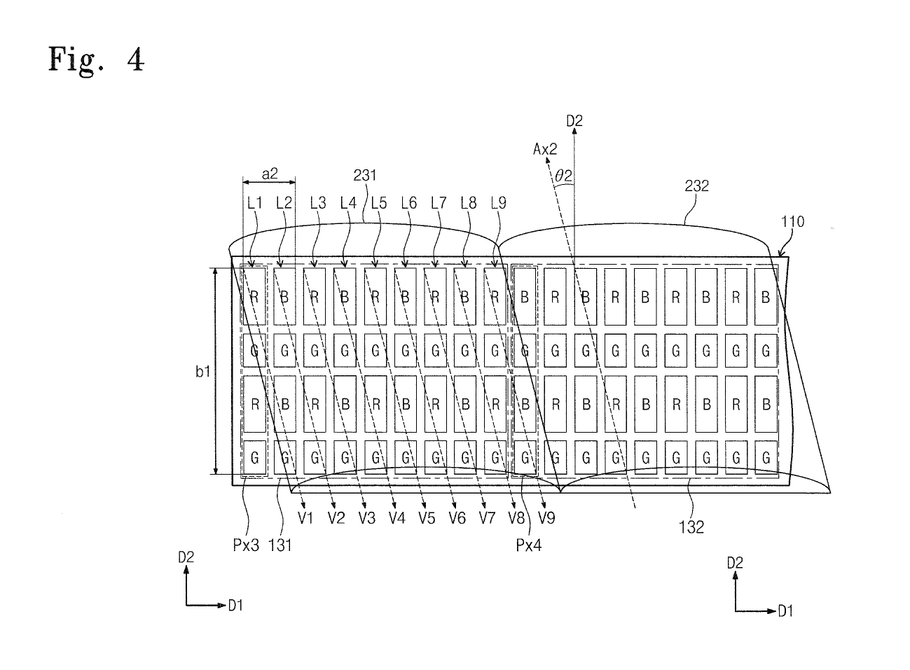

FIG. 4 is a plan view showing lenticular lenses arranged on a display panel 110 according to an exemplary embodiment of the present invention.

Referring to FIG. 4, lenticular lenses 231 and 232 are disposed on the display panel 110. The display panel 110 includes a first region 131 and a second region 132 corresponding to the lenticular lenses 231 and 232, respectively. A third pixel pattern Px3 and a fourth pixel pattern Px4 are sequentially alternately arranged in first to ninth lines L1 to L9 of the first region 131 along the first direction D1, and the fourth pixel pattern Px4 and the third pixel pattern Px3 are sequentially alternately arranged in first to ninth lines L1 to L9 of the second region 132 along the first direction D1. For instance, the third pixel pattern Px3 is arranged in the first line L1 of the first region 131 and the fourth pixel pattern Px4 is arranged in the first line L1 of the second region 132. In addition, the fourth pixel pattern Px4 is arranged in the second line L2 of the first region 131 and the third pixel pattern Px3 is arranged in the second line L2 of the second region 132.

The lenticular lenses 231 and 232 disposed on the display panel 110 have a lens axis Ax2 inclined in a counter-clockwise direction by an inclination angle θ2 with respect to the second direction D2. These lenses are different from the lenticular lenses 211 and 212 shown in FIG. 2. The lenticular lenses 231 and 232 are extended along the lens axis Ax2 and arranged in the first direction D1 to be substantially parallel with each other.

The inclination angle θ2 of the lens axis Ax2 may be defined by the following equation 2 according to the structure of the color cells in the display panel 110.

$$tan ( θ 2 ) = \frac{a 2}{b 1} \qquad Equation 2$$

In equation 2, b1 denotes a length of one pixel pattern in the second direction D2 and a2 denotes a length of two color cells adjacent to each other in the first direction D1. The expression a2 includes a length of a light blocking pattern disposed between the two adjacent color cells.

First to ninth viewpoint lines V1 to V9 are substantially parallel with the lens axis Ax2 of the lenticular lenses 231 and 232. The first viewpoint line V1 substantially parallel with the lens axis Ax2 is disposed on the red cell R and the green cell G of the first line L1 and the blue cell B and the green cell G of the second line L2. The second viewpoint line V2 substantially parallel with the first viewpoint line V1 is disposed on the blue cell B and the green cell G of the second line L2 and the red cell R and the green cell G of the third line L3. Each of the third, fifth, seventh, and ninth viewpoint lines V3, V5, V7, and V9, which is substantially parallel with the first viewpoint line V1, is disposed on the red cell R and the green cell G of the third, fifth, seventh and ninth lines L3, L5, L7 and L9, respectively, and the blue cell B and the green cell G of the fourth, sixth and eighth lines L4, L6 and L8 of the first region 131 and a first line L1 of the second region 132, respectively. Each of the fourth, sixth, and eighth viewpoint lines V4, V6, and V8, which is substantially parallel with the first viewpoint line V1, is disposed on the blue cell B and the green cell G of the fourth, sixth and eighth lines L4, L6 and L8, respectively, and the red cell R and the green cell G of the fifth, seventh and ninth lines L5, L7 and L9, respectively. As a result, a moiré phenomenon may be prevented from occurring when an observer's eyes converge on a boundary between adjacent color cells.

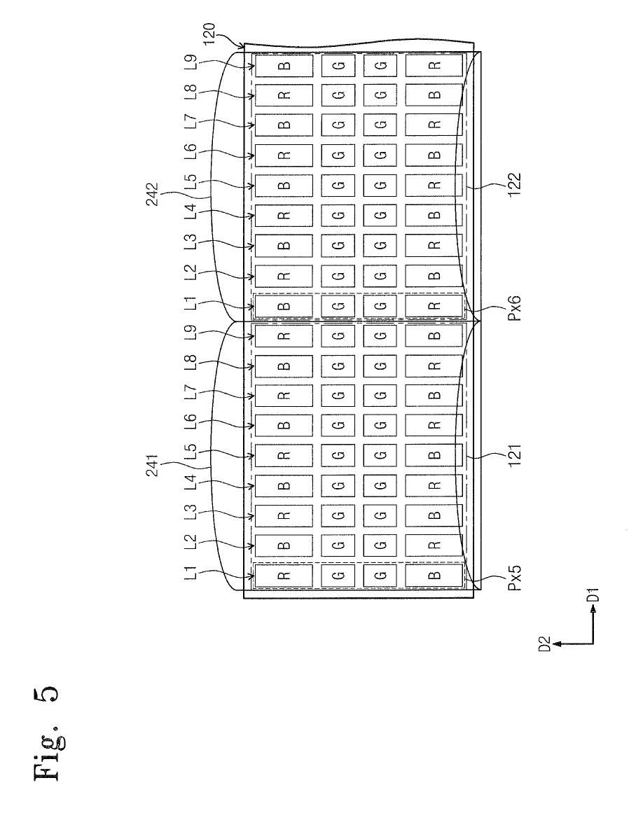

FIG. 5 is a plan view showing color cells arranged in a display panel 120 according to an exemplary embodiment of the present invention.

Referring to FIG. 5, lenticular lenses 241 and 242 are disposed on the display panel 120. The display panel 120 includes a first region 121 and a second region 122 corresponding to the lenticular lenses 241 and 242, respectively. In FIG. 5, a portion of the display panel 120 has been shown, and thus the display panel 120 includes the first region 121 and the second region 122, but the number of the regions defined on the display panel 120 depends on the resolution of the display panel 120. For instance, when the display panel 120 has a resolution of 1920×1080, (1920×3) color cells are arranged in the first direction D1. Since each lenticular lens may be overlapped with nine color cells as shown in FIG. 1, the number of the regions defined on the display panel 120 is ((1920×3)/9).

Each of the first region 121 and the second region 122 includes first to ninth lines L1 to L9 extended in the second direction D2 and repeatedly arranged in the first direction D1. Each of the first to ninth lines L1 to L9 includes a fifth pixel pattern Px5 in which first to fourth color cells are arranged in the second direction D2 or a sixth pixel pattern Px6 different from the fifth pixel pattern Px5. Thus, the first to fourth color cells are repeatedly arranged in the first direction D1 and the second direction D2 to form the matrix. The color cells arranged in the first direction D1 are spaced apart from each other and the color cells arranged in the second direction D2 are spaced apart from each other.

The first, second, third, and fourth color cells respectively correspond to the red cell R, the green cell G, the green cell G, and the blue cell B. The fifth pixel pattern Px5 includes the red cell R, the green cell G, the green cell G, and the blue cell B sequentially arranged in the second direction D2. The sixth pixel pattern Px6 includes the blue cell B, the green cell G, the green cell G, and the red cell R sequentially arranged in the second direction D2. Either the fifth pixel pattern Px5 or the sixth pixel pattern Px6 is provided in each of the first to ninth lines L1 to L9.

Each of the first to fourth color cells includes a short side extended in the first direction D1 and a long side extended in the second direction D2. The long side of the red cell R and the blue cell B provided as the first and fourth color cells is two times longer than the long side of the green cell G provided as the second and third color cells. In other words, a ratio of the long side of the red cell R to the long side of the green cell G is about 1:0.5 and a ratio of the long side of the blue cell B to the long side of the green cell G is about 1:0.5.

As shown in FIG. 5, the fifth pixel pattern Px5 and the sixth pixel pattern Px6 are alternately arranged in the first to ninth lines L1 to L9 of the first region 121 along the first direction D1, and the sixth pixel pattern Px6 and the fifth pixel pattern Px5 are alternately arranged in the first to ninth lines L1 to L9 of the second region 122 along the first direction D1. For instance, the fifth pixel pattern Px5 is arranged in the first line L1 of the first region 121 and the sixth pixel pattern Px6 is arranged in the first line L1 of the second region 122. In addition, the sixth pixel pattern Px6 is arranged in the second line L2 of the first region 121 and the fifth pixel pattern Px5 is arranged in the second line L2 of the second region 122.

When each of the first and second regions 121 and 122 includes an odd number of lines, the last line, e.g., the ninth line L9, of the first region 121 and the first line L1 of the second region 122 include different pixel patterns from each other. For example, the ninth line L9 of the first region 121 may include the fifth pixel pattern Px5 and the first line L1 of the second region 122 may include the sixth pixel pattern Px6. However, when each of the first and second regions 121 and 122 includes an even number of the lines, the last line, e.g., the eighth line L8, of the first region 121 and the first line L1 of the second region 122 may include the same pixel pattern. For example, the eighth line L8 of the first region 121 and the first line L1 of the second region 122 may include the fifth pixel pattern Px5, or the eighth line L8 of the first region 121 and the first line L1 of the second region 122 may include the sixth pixel pattern Px6. In this case, each of the lines arranged in the first region 121 includes a pixel pattern different from a pixel pattern arranged in a corresponding line of the second region 122.

As described above, since the fifth and sixth pixel patterns Px5 and Px6 are alternately arranged in corresponding lines of the first and second regions 121 and 122, adjacent color cells may have different colors from each other in each of first to ninth viewpoints, thereby improving the quality of the 3D image.

Further, each pair of the fifth pixel pattern Px5 in which the red cell R, the green cell G, the green cell G, and the blue cell B are sequentially arranged in the second direction D2 and the sixth pixel pattern Px6 in which the blue cell B, the green cell G, the green cell G, and the red cell R are sequentially arranged in the second direction D2 forms two pixels with four color cells in each pixel. Accordingly, the number of the color cells (e.g., sub-pixels) in the second direction D2 may be reduced by ⅓ as compared with a six color cell per pixel pair of pixels, so that the resolution of the display panel 120 may be improved.

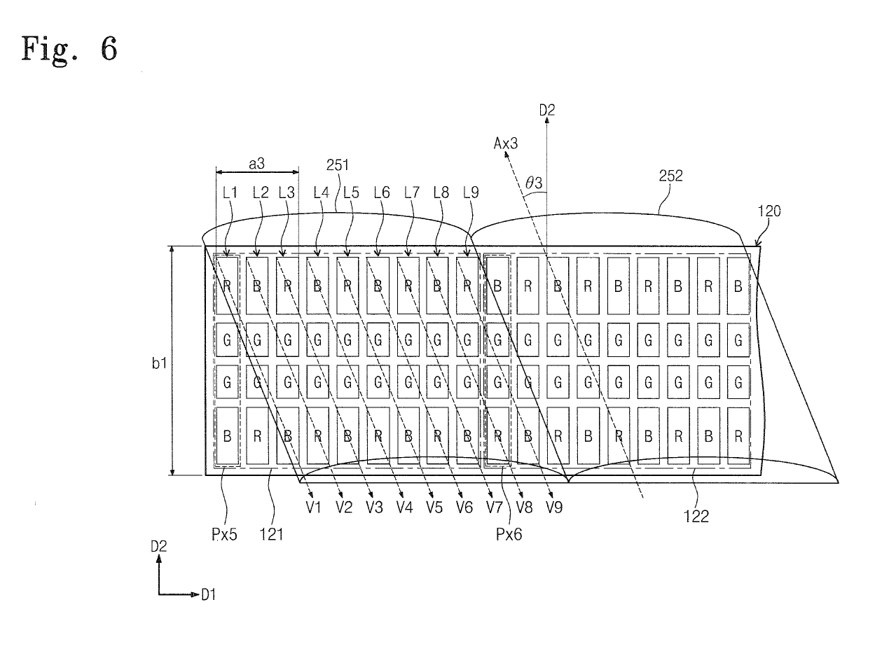

FIG. 6 is a plan view showing lenticular lenses arranged on the display panel 120 shown in FIG. 5 according an exemplary embodiment of the present invention.

Referring to FIG. 6, lenticular lenses 251 and 252 disposed on the display panel 120 have a lens axis Ax3 inclined in a counter-clockwise direction by an inclination angle θ3 with respect to the second direction D2. These lenses are different from the lenticular lenses 241 and 242 shown in FIG. 5. The lenticular lenses 251 and 252 are extended along the lens axis Ax3 and arranged in the first direction D1 to be substantially parallel with each other.

The inclination angle θ3 of the lens axis Ax3 may be defined by the following equation 3 according to the structure of the color cells in the display panel 120.

$$tan ( θ 3 ) = \frac{a 3}{b 1} \qquad Equation 3$$

In equation 3, b1 denotes a length of one pixel pattern in the second direction D2 and a3 denotes a length of three color cells adjacent to each other in the first direction D1. The expression a3 includes a length of two light blocking patterns disposed between the three adjacent color cells.

First to ninth viewpoint lines V1 to V9 are substantially parallel with the lens axis Ax3 of the lenticular lenses 251 and 252. The first viewpoint line V1 substantially parallel with the lens axis Ax3 is disposed on the red cell R of the first line L1, two green cells G of the second line L2, and the blue cell B of the third line L3. The second viewpoint line V2 substantially parallel with the first viewpoint line V1 is disposed on the blue cell B of the second line L2, two green cells G of the third line L3, and the red cell R of the fourth line L4. Each of the third, fifth, seventh, and ninth viewpoint lines V3, V5, V7, and V9, which is substantially parallel with the first viewpoint line V1, is disposed on the red cell R of the third, fifth, seventh and ninth lines L3, L5, L7 and L9, respectively, the green cell G and the green cell G of the fourth, sixth and eighth lines L4, L6 and L8 of the first region 121 and the first line L1 of the second region 122, respectively, and the blue cell B of the fifth, seventh and ninth lines L5, L7 and L9 of the first region 121 and the second line L2 of the second region 122, respectively. Each of the fourth, sixth, and eighth viewpoint lines V4, V6, and V8, which is substantially parallel with the first viewpoint line V1, is disposed on the blue cell B of the fourth, sixth and eighth lines L4, L6 and L8, respectively, the green cell G and the green cell G of the fifth, seventh and ninth lines L5, L7 and L9, respectively, and the red cell R of the sixth and eight lines L6 and L8 of the first region 121 and the first line L1 of the second region 122, respectively. As a result, a moiré phenomenon may be prevented from occurring when an observer's eyes converge on a boundary between adjacent color cells.

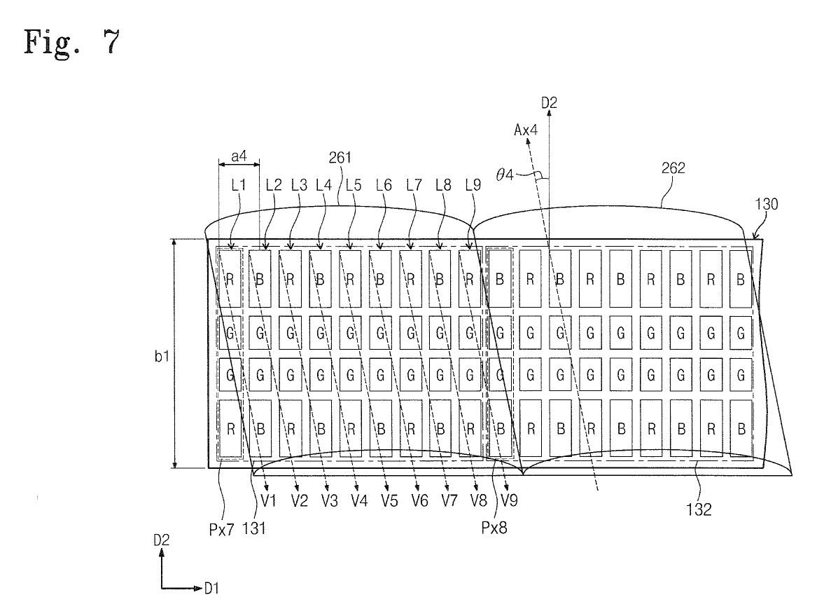

FIG. 7 is a plan view showing lenticular lenses arranged on a display panel according to an exemplary embodiment of the present invention.

Referring to FIG. 7, the display panel 130 includes a first region 131 and a second region 132 corresponding to lenticular lenses 261 and 262, respectively. In FIG. 7, a portion of the display panel 130 has been shown, and thus the display panel 130 includes the first region 131 and the second region 132, but the number of the regions defined on the display panel 130 depends on the resolution of the display panel 130. For instance, when the display panel 130 has a resolution of 1920×1080, (1920×3) color cells are arranged in the first direction D1. Since each lenticular lens may be overlapped with nine color cells as shown in FIG. 1, the number of the regions defined on the display panel 130 is ((1920×3)/9).

Each of the first region 131 and the second region 132 includes first to ninth lines L1 to L9 extended in the second direction D2 and repeatedly arranged in the first direction D1. Each of the first to ninth lines L1 to L9 includes a seventh pixel pattern Px7 in which first to fourth color cells are arranged in the second direction D2 or an eighth pixel pattern Px8 different from the seventh pixel pattern Px7. Therefore, the first to fourth color cells are repeatedly arranged in the first direction D1 and the second direction D2 to form the matrix. The color cells arranged in the first direction D1 are spaced apart from each other and the color cells arranged in the second direction D2 are spaced apart from each other.

The first, second, third, and fourth color cells respectively correspond to the red cell R (or blue cell B), the green cell G, the green cell G, and the red cell R (or blue cell B). The seventh pixel pattern Px7 includes the red cell R, the green cell G, the green cell G, and the red cell R sequentially arranged in the second direction D2. The eighth pixel pattern Px8 includes the blue cell B, the green cell G, the green cell G, and the blue cell B sequentially arranged in the second direction D2. Either the seventh pixel pattern Px7 or the eighth pixel pattern Px8 is provided in each of the first to ninth lines L1 to L9.

Each of the first to fourth color cells includes a short side extended in the first direction D1 and a long side extended in the second direction D2. The long side of the red cell R and the blue cell B provided as the first and fourth color cells is two times longer than the long side of the green cell G provided as the second and third color cells. In other words, a ratio of the long side of the red cell R to the long side of the green cell G is about 1:0.5 and a ratio of the long side of the blue cell B to the long side of the green cell G is about 1:0.5.

As shown in FIG. 7, the seventh pixel pattern Px7 and the eight pixel pattern Px8 are alternately arranged in the first to ninth lines L1 to L9 of the first region 131 along the first direction D1, and the eight pixel pattern Px8 and the seventh pixel pattern Px7 are alternately arranged in the first to ninth lines L1 to L9 of the second region 132 along the first direction D1. For instance, the seventh pixel pattern Px7 is arranged in the first line L1 of the first region 131 and the eighth pixel pattern Px8 is arranged in the first line L1 of the second region 132. In addition, the eighth pixel pattern Px8 is arranged in the second line L2 of the first region 131 and the seventh pixel pattern Px7 is arranged in the second line L2 of the second region 132.

When each of the first and second regions 131 and 132 includes an odd number of lines, the last line, e.g., the ninth line L9, of the first region 131 and the first line L1 of the second region 132 include different pixel patterns from each other. For example, the ninth line L9 of the first region 131 may include the seventh pixel pattern Px7 and the first line L1 of the second region 132 may include the eighth pixel pattern Px8. However, when each of the first and second regions 131 and 132 includes an even number of the lines, the last line, e.g., the eighth line L8 of the first region 131 and the first line L1 of the second region 132 may include the same pixel pattern. For example, the eighth line L8 of the first region 131 and the first line L1 of the second region 132 may include the seventh pixel pattern Px7, or the eighth line L8 of the first region 131 and the first line L1 of the second region 132 may include the eighth pixel pattern Px8. In this case, each of the lines arranged in the first region 131 includes a pixel pattern different from a pixel pattern arranged in a corresponding line of the second region 132.

The lenticular lenses 261 and 262 disposed on the display panel 130 have a lens axis Ax4 inclined in a counter-clockwise direction by an inclination angle θ4 with respect to the second direction D2. These lenses are different from the lenticular lenses 241 and 242 shown in FIG. 5. The lenticular lenses 261 and 262 are extended along the lens axis Ax4 and arranged in the first direction D1 to be substantially parallel with each other.

The inclination angle θ4 of the lens axis Ax4 may be defined by the following equation 4 according to the structure of the color cells in the display panel 130.

$$tan ( θ 4 ) = \frac{a 4}{b 1} \qquad Equation 4$$

In equation 4, b1 denotes a length of one pixel pattern in the second direction D2 and a4 denotes a length of one and half of two color cells adjacent to each other in the first direction D1. The expression a4 includes a length of the light blocking pattern disposed between the two adjacent color cells.

First to ninth viewpoint lines V1 to V9 are substantially parallel with the lens axis Ax4 of the lenticular lenses 261 and 262. The first viewpoint line V1 substantially parallel with the lens axis Ax4 is disposed on the red cell R and the green cell G of the first line L1 and the green cell G and the blue cell B of the second line L2. The second viewpoint line V2 substantially parallel with the first viewpoint line V1 is disposed on the blue cell B and the green cell G of the second line L2 and the green cell G and the red cell R of the third line L3. Each of the third, fifth, seventh, and ninth viewpoint lines V3, V5, V7, and V9 is disposed on the red cell R and the green cell G of the third, fifth, seventh and ninth lines L3, L5, L7 and L9, respectively, and the green cell G and the blue cell B of the fourth, sixth and eighth lines L4, L6 and L8 of the first region 131 and the first line L1 of the second region 132, respectively. Each of the fourth, sixth, and eighth viewpoint lines V4, V6, and V8 is disposed on the blue cell B and the green cell G of the fourth, sixth and eighth lines L4, L6 and L8, respectively, and the green cell G and the red cell R of the fifth, seventh and ninth lines L5, L7 and L9, respectively. As a result, a moiré phenomenon may be prevented from occurring when an observer's eyes converge on a boundary between adjacent color cells.

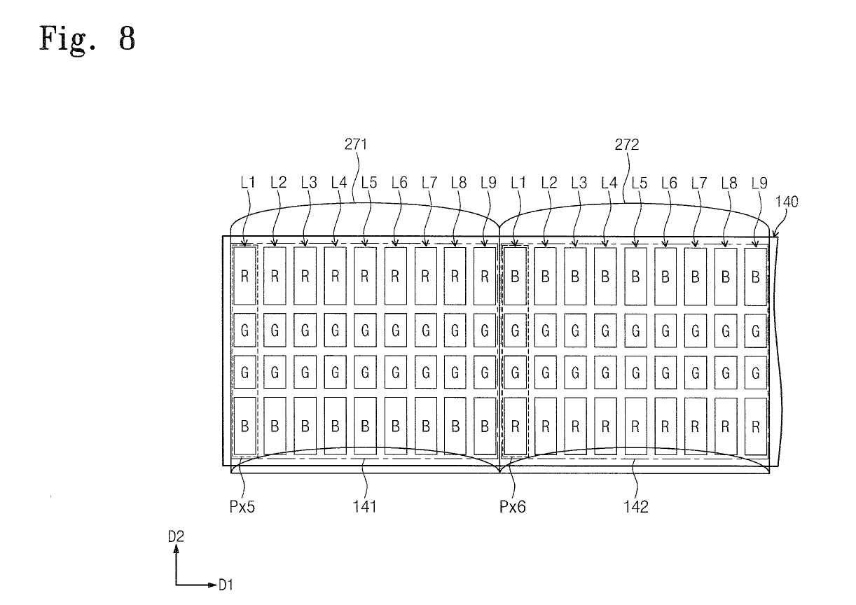

FIG. 8 is a plan view showing color cells arranged in a display panel 140 according to an exemplary embodiment of the present invention.

Referring to FIG. 8, lenticular lenses 271 and 272 are disposed on the display panel 140. The display panel 140 includes a first region 141 and a second region 142 corresponding to the lenticular lenses 271 and 272, respectively. In FIG. 8, since a portion of the display panel 140 has been shown, the display panel 140 includes the first region 141 and the second region 142. However, the number of the regions defined on the display panel 140 depends on the resolution of the display panel 140. For instance, when the display panel 140 has a resolution of 1920×1080, (1920×3) color cells are arranged in the first direction D1. In the case that each lenticular lens is overlapped with nine color cells, the number of the regions defined on the display panel 140 is ((1920×3)/9).

Each of the first region 141 and the second region 142 includes first to ninth lines L1 to L9 extended in the second direction D2 and repeatedly arranged in the first direction D1. Each of the first to ninth lines L1 to L9 of the first region 141 includes the red cell R, the green cell G, the green cell G, and the blue cell B (e.g., the fifth pixel pattern Px5) sequentially arranged in the second direction D2. Each of the first to ninth lines L1 to L9 of the second region 142 includes the blue cell B, the green cell G, the green cell G, and the red cell R (e.g., the sixth pixel pattern Px6) sequentially arranged in the second direction D2.

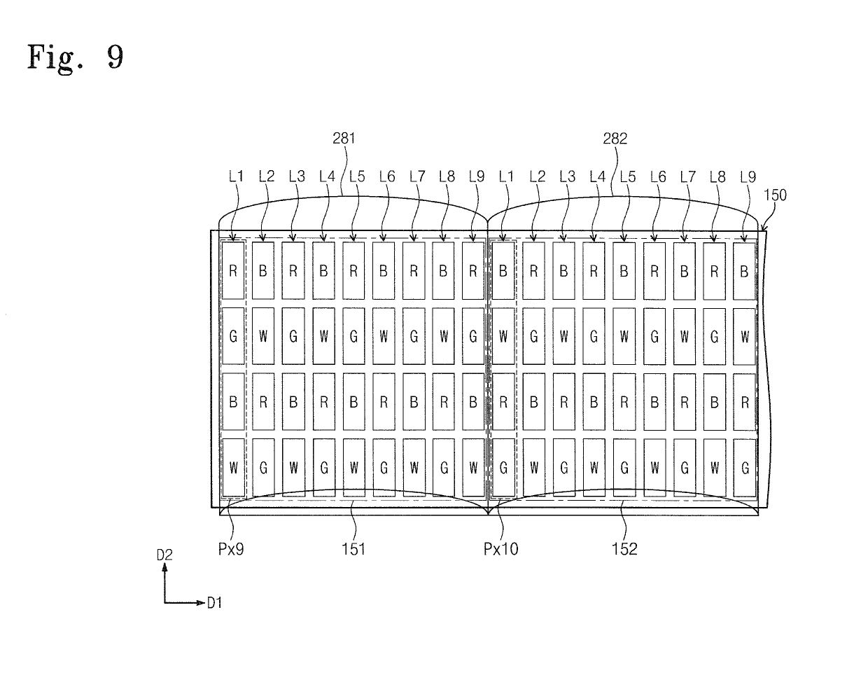

FIG. 9 is a plan view showing color cells arranged in a display panel 150 according to an exemplary embodiment of the present invention.

Referring to FIG. 9, lenticular lenses 281 and 282 are disposed on the display panel 150. The display panel 150 includes a first region 151 and a second region 152 corresponding to the lenticular lenses 281 and 282, respectively. In FIG. 9, a portion of the display panel 150 has been shown, and thus the display panel 150 includes the first region 151 and the second region 152 in FIG. 9, but the number of the regions defined on the display panel 150 depends on the resolution of the display panel 150. For instance, when the display panel 150 has a resolution of 1920×1080, (1920×3) color cells are arranged in the first direction D1. Since each lenticular lens may be overlapped with nine color cells as shown in FIG. 1, the number of the regions defined on the display panel 150 is ((1920×3)/9).

Each of the first region 151 and the second region 152 includes first to ninth lines L1 to L9 extended in the second direction D2 and repeatedly arranged in the first direction D1. Each of the first to ninth lines L1 to L9 includes a ninth pixel pattern Px9 in which first to fourth color cells are arranged in the second direction D2 or a tenth pixel pattern Px10 different from the ninth pixel pattern Px9. Thus, the first to fourth color cells are repeatedly arranged in the first direction D1 and the second direction D2 to form the matrix. The color cells arranged in the first direction D1 are spaced apart from each other by a predetermined distance and the color cells arranged in the second direction D2 are spaced apart from each other by a predetermined distance.

The first, second, third, and fourth color cells respectively correspond to the red cell R, the green cell G, the blue cell B, and a white cell W. The ninth pixel pattern Px9 includes the red cell R, the green cell G, the blue cell B, and the white cell W sequentially arranged in the second direction D2. The tenth pixel pattern Px10 includes the blue cell B, the white cell W, the red cell R, and the green cell G sequentially arranged in the second direction D2. Either the ninth pixel pattern Px9 or the tenth pixel pattern Px10 is provided in each of the first to ninth lines L1 to L9.

As shown in FIG. 9, the ninth pixel pattern Px9 and the tenth pixel pattern Px10 are alternately arranged in the first to ninth lines L1 to L9 of the first region 151 along the first direction D1 and the tenth pixel pattern Px10 and the ninth pixel pattern Px9 are alternately arranged in the first to ninth lines L1 to L9 of the second region 152 along the first direction D1. For instance, the ninth pixel pattern Px9 is arranged in the first line L1 of the first region 151 and the tenth pixel pattern Px10 is arranged in the first line L1 of the second region 152. In addition, the tenth pixel pattern Px10 is arranged in the second line L2 of the first region 151 and the ninth pixel pattern Px9 is arranged in the second line L2 of the second region 152.

When each of the first and second regions 151 and 152 includes an odd number of lines, the last line, e.g., the ninth line L9, of the first region 151 and the first line L1 of the second region 152 include different pixel patterns from each other. For example, the ninth line L9 of the first region 151 may include the ninth pixel pattern Px9 and the first line L1 of the second region 152 may include the tenth pixel pattern Px10. However, when each of the first and second regions 151 and 152 includes an even number of the lines, the last line, e.g., the eighth line L8) of the first region 151 and the first line L1 of the second region 152 may include the same pixel pattern. For example, the eighth line L8 of the first region 151 and the first line L1 of the second region 152 may include the ninth pixel pattern Px9, or the eighth line L8 of the first region 151 and the first line L1 of the second region 152 may include the tenth pixel pattern Px10. In this case, each of the lines arranged in the first region 151 includes a pixel pattern different from a pixel pattern arranged in a corresponding line of the second region 152.

As described above, since the ninth and tenth pixel patterns Px9 and Px10 are alternately arranged in corresponding lines of the first and second regions 151 and 152, adjacent color cells may have different colors from each other in each of first to ninth viewpoints, thereby improving the quality of the 3D image.

Further, each pair of the ninth pixel pattern Px9 in which the red cell R, the green cell G, the blue cell B, and the white cell W are sequentially arranged in the second direction D2 and the tenth pixel pattern Px10 in which the blue cell B, the white cell W, the red cell R, and the green cell G are sequentially arranged in the second direction D2 forms two pixels with four color cells in each pixel. Thus, the number of the color cells (e.g., sub-pixels) in the second direction D2 may be reduced by ⅓ as compared with a six color cell per pixel pair of pixels, so that the resolution of the display panel 150 may be improved. In addition, since each pixel includes the white cell W, the display panel 150 may have reduced power consumption and improved brightness.

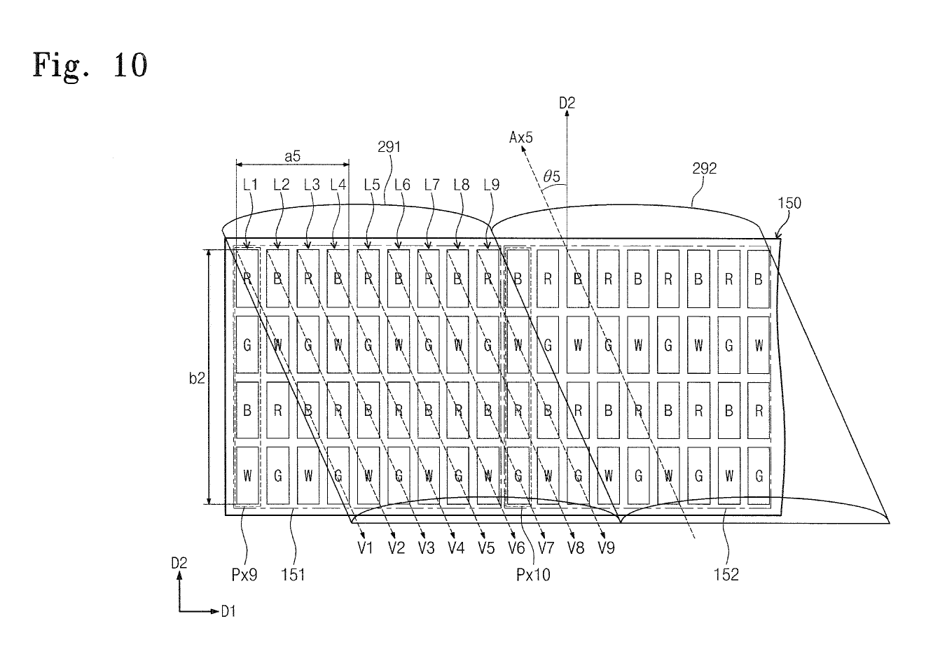

FIG. 10 is a plan view showing lenticular lenses arranged on the display panel 150 shown in FIG. 9 according an exemplary embodiment of the present invention.

Referring to FIG. 10, lenticular lenses 291 and 292 disposed on the display panel 150 have a lens axis Ax5 inclined in a counter-clockwise direction by an inclination angle θ5 with respect to the second direction D2. These lenses are different from the lenticular lenses 281 and 282 shown in FIG. 9. The lenticular lenses 291 and 292 are extended along the lens axis Ax5 and arranged in the first direction D1 to be substantially parallel with each other.

The inclination angle θ5 of the lens axis Ax5 may be defined by the following equation 5 according to the structure of the color cells in the display panel 150.

$$tan ( θ 5 ) = \frac{a 5}{b 2} \qquad Equation 5$$

In equation 5, b2 denotes a length of one pixel pattern in the second direction D2 and a5 denotes a length of four color cells adjacent to each other in the first direction D1. The expression a5 includes a length of three light blocking patterns disposed between the four adjacent color cells.

First to ninth viewpoint lines V1 to V9 are substantially parallel with the lens axis Ax5 of the lenticular lenses 291 and 292. The first viewpoint line V1 substantially parallel with the lens axis Ax5 is disposed on the red cell R of the first line L1, the white cell W of the second line L2, the blue cell B of the third line L3, and the green cell G of the fourth line L4. The second viewpoint line V2 substantially parallel with the first viewpoint line V1 is disposed on the blue cell B of the second line L2, the green cell G of the third line L3, the red cell R of the fourth line L4, and the white cell W of the fifth line L5. As described above, each of the third, fifth, seventh, and ninth viewpoint lines V3, V5, V7, and V9 is disposed on the red cell R of the third, fifth, seventh and ninth lines L3, L5, L7 and L9, respectively, the white cell W of fourth, sixth and eighth lines L4, L6 and L8 of the first region 151 and the first line L1 of the second region 152, respectively, the blue cell B of the fifth, seventh and ninth lines L5, L7 and L9 of the first region 151 and the second line L2 of the second region 152, respectively, and the green cell G of the sixth and eighth lines L6 and L8 of the first region 151 and the first and third lines L1 and L3 of the second region 152, respectively. Each of the fourth, sixth, and eighth viewpoint lines V4, V6, and V8 is disposed on the blue cell B of the fourth, sixth and eighth lines L4, L6 and L8, respectively, the green cell G of the fifth, seventh and ninth lines L5, L7 and L9, respectively, the red cell R of the sixth and eighth lines L6 and L8 of the first region 151 and the first and third lines L1 and L3 of the second region 152, respectively, and the white cell W of the seventh and ninth lines L7 and L9 of the first region 151 and the second and fourth lines L2 and L4 of the second region 152, respectively. As a result, a moiré phenomenon may be prevented from occurring when an observer's eyes converge on a boundary between adjacent color cells.

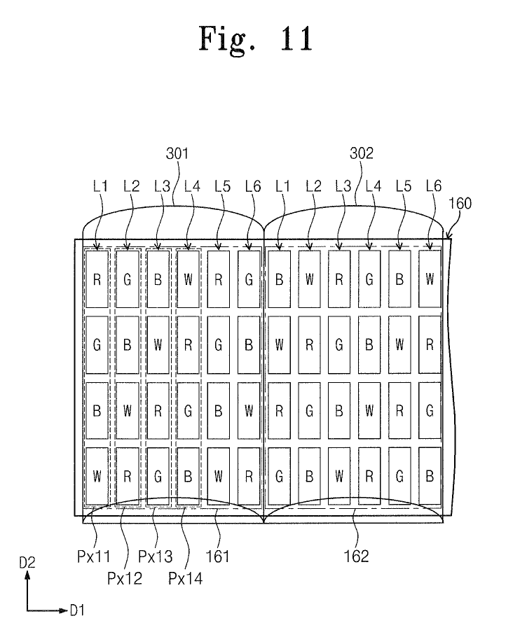

FIG. 11 is a plan view showing color cells arranged in a display panel 160 according to an exemplary embodiment of the present invention.

Referring to FIG. 11, lenticular lenses 301 and 302 are disposed on the display panel 160. The display panel 160 includes a first region 161 and a second region 162 corresponding to the lenticular lenses 301 and 302, respectively. In FIG. 11, a portion of the display panel 160 has been shown, and thus the display panel 160 includes the first region 161 and the second region 162 in FIG. 11, but the number of the regions defined on the display panel 160 depends on the resolution of the display panel 160. For instance, when the display panel 160 has a resolution of 1920×1080, (1920×3) color cells are arranged in the first direction D1. Since each lenticular lens may be overlapped with nine color cells as shown in FIG. 1, the number of the regions defined on the display panel 160 is ((1920×3)/9).

Each of the first region 161 and the second region 162 includes first to sixth lines L1 to L6 extended in the second direction D2 and repeatedly arranged in the first direction D1. Each of the first to sixth lines L1 to L6 includes first to fourth color cells arranged in the second direction D2. Thus, the first to fourth color cells are repeatedly arranged in the first direction D1 and the second direction D2 to form the matrix. The color cells arranged in the first direction D1 are spaced apart from each other by a predetermined distance and the color cells arranged in the second direction D2 are spaced apart from each other by a predetermined distance.

The first, second, third, and fourth color cells respectively correspond to the red cell R, the green cell G, the blue cell B, and the white cell W. Pixel pattern Px11 includes the red cell R, the green cell G, the blue cell B, and the white cell W sequentially arranged in the second direction D2. Pixel pattern Px12 includes the green cell G, the blue cell B, the white cell W, and the red cell R sequentially arranged in the second direction D2. Pixel pattern Px13 includes the blue cell B, the white cell W, the red cell R, and the green cell G sequentially arranged in the second direction D2. Pixel pattern Px14 includes the white cell W, the red cell R, the green cell G, and the blue cell B sequentially arranged in the second direction D2.

As shown in FIG. 11, the pixel patterns Px11, Px12, Px13, Px14, Px11 and Px12 are sequentially arranged in the first direction D1 in the first to sixth lines L1 to L6 of the first region 161, and the pixel patterns Px13, Px14, Px11, Px12, Px13 and Px14 are sequentially arranged in the first direction D1 in the first to sixth lines L1 to L6 of the second region 162.

In the display panel 160, each of the color cells has a color different from those of the color cells adjacent thereto in the first and second directions D1 and D2, and thus the quality of an image displayed on each line in the first and second directions D1 and D2 may be improved.

According to the above described exemplary embodiments of the present invention, although the number of the viewpoints of the 3D image display increases, the resolution of a 3D image displayed on the 3D image display may not be deteriorated.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A three-dimensional (3D) image display, comprising:
a display panel including a plurality of regions arranged in a first direction; and
an image converting unit disposed on the display panel to convert a two-dimensional (2D) image displayed on the display panel into a 3D image,
wherein each of a first region and a second region of the plurality of regions comprises a plurality of columns sequentially arranged in the first direction, a first pixel pattern or a second pixel pattern is included in each of the columns, the first and second pixel patterns each comprise first, second, third, and fourth color cells arranged in a second direction different from the first direction, the arrangement of the first to fourth color cells in the first pixel pattern is different from the arrangement of the first to fourth color cells in the second pixel pattern, and the first and second pixel patterns are alternately arranged in corresponding columns of the first and second regions.

2. The 3D image display of claim 1, wherein the second color cell and the fourth color cell comprise a same color and in the second pixel pattern the third color cell, the second color cell, the first color cell, and the fourth color cell are sequentially arranged in the second direction.

3. The 3D image display of claim 2, wherein the first and third color cells have a same length in the second direction, the second and fourth color cells have a same length in the second direction, and a ratio of the length of each of the first and third color cells to the length of each of the second and fourth color cells is about 1:0.5.

4. The 3D image display of claim 2, wherein the first color cell is a red cell, each of the second and fourth color cells is a green cell, and the third color cell is a blue cell.

5. The 3D image display of claim 1, wherein the second color cell and the third color cell have a same color and in the second pixel pattern the fourth color cell, the second color cell, the third color cell, and the first color cell are sequentially arranged in the second direction.

6. The 3D image display of claim 5, wherein the first and fourth color cells have a same length in the second direction, the second and third color cells have a same length in the second direction, and a ratio of the length of each of the first and fourth color cells to the length of each of the second and third color cells is about 1:0.5.

7. The 3D image display of claim 6, wherein the first color cell is a red cell, each of the second and third color cells is a green cell, and the fourth color cell is a blue cell.

8. The 3D image display of claim 1, wherein the first, second, third, and fourth color cells have different colors from each other and in the second pixel pattern the third color cell, the fourth color cell, the first color cell, and the second color cell are sequentially arranged in the second direction.

9. The 3D image display of claim 8, wherein the first, second, third, and fourth color cells correspond to red, green, blue, and white cells, respectively.

10. The 3D image display of claim 1, wherein the columns of the first region have different viewpoints from each other and the columns of the second region have different viewpoints from each other, wherein the corresponding columns of the first and second regions have a same viewpoint.

11. The 3D image display of claim 1, wherein the first pixel pattern and the second pixel pattern are alternately arranged in the columns of each of the first and second regions.

12. The 3D image display of claim 1, wherein the image converting unit comprises a plurality of lenticular lenses.

13. The 3D image display of claim 12, wherein a first lenticular lens and a second lenticular lens of the lenticular lenses respectively correspond to the first and second regions and each of the first and second lenticular lenses has a lens axis substantially parallel with the second direction.

14. The 3D image display of claim 12, wherein a first lenticular lens and a second lenticular lens of the lenticular lenses are extended in the second direction and arranged in the first direction and each of the first and second lenticular lenses is overlapped with a plurality of the color cells arranged in the first direction.

15. The 3D image display of claim 12, wherein each of a first lenticular lens and a second lenticular lens of the lenticular lenses has a lens axis inclined at a first angle with respect to the second direction.

16. The 3D image display of claim 1, wherein the image converting unit comprises a plurality of viewpoint dividing devices, a first viewpoint dividing device and a second viewpoint dividing device of the viewpoint dividing devices are extended in the second direction and arranged in the first direction, and each of the first and second viewpoint dividing devices is overlapped with a plurality of the color cells arranged in the first direction.

17. A three-dimensional (3D) image display, comprising:
a display panel including a plurality of regions arranged in a first direction; and
an image converting unit disposed on the display panel to convert a two-dimensional (2D) image displayed on the display panel into a 3D image,
wherein each of a first region and a second region of the plurality of regions comprises a plurality of columns sequentially arranged in the first direction, first, second, third and fourth pixel patterns are arranged in the columns of each of the first and second regions in a second direction different from the first direction, the first to fourth pixel patterns include first, second, third and fourth color cells different from each other,
in the first pixel pattern the first, second, third and fourth color cells are sequentially arranged in the second direction, in the second pixel pattern the second, third, fourth and first color cells are sequentially arranged in the second direction, in the third pixel pattern the third, fourth, first and second color cells are sequentially arranged in the second direction, and in the fourth pixel pattern the fourth, first, second and third color cells are sequentially arranged in the second direction.

18. The 3D image display of claim 17, wherein the first to fourth pixel patterns are sequentially arranged in the first direction in each of the first and second regions.

19. The 3D image display of claim 17, wherein the first, second, third and fourth color cells correspond to red, green, blue and white cells, respectively.

20. A three-dimensional (3D) image display, comprising:
a display panel including a first region and a second region, wherein the first region includes a plurality of columns and the second region includes a plurality of columns;
a first lens disposed over the first region; and
a second lens disposed over the second region,
wherein a first pixel pattern and a second pixel pattern are alternately arranged in the columns of each of the first and second regions in a first direction, the first pixel pattern and the second pixel pattern each include at least four color cells arranged in a second direction different from the first direction, and the arrangement of the color cells in the first pixel pattern is different from the arrangement of the color cells in the second pixel pattern.
